(19) United States
(12) Patent Application Publication
(10) Pub. No.: US 2020/0257981 A1
(43) Pub. Date: Aug. 13, 2020

(54) METHOD FOR EXECUTING ACTIVATION FUNCTION FOR DEEP LEARNING ALGORITHM, AND APPARATUS FOR EXECUTING SAID METHOD

(71) Applicant: MARKANY INC., Seoul (KR)

(72) Inventors: Seung Yeob CHAE, Seoul (KR); So Won KIM, Seoul (KR); Min Soo PARK, Uiwang-si (KR)

(21) Appl. No.: 16/358,701

(22) Filed: Mar. 20, 2019

(30) Foreign Application Priority Data
Feb. 7, 2019 (KR) 10-2019-0014432

(51) Int. Cl. G06N 3/08; G06N 3/04; G06F 17/11

(52) U.S. Cl. CPC G06N 3/082; G06F 17/11; G06N 3/0481

(57) ABSTRACT

Disclosed is a method for executing an activation function for a deep learning algorithm. The method includes: determining whether an input value to a first node of an artificial neural network related to the deep learning algorithm is positive or negative; executing a first activation function in response to the input value being positive, or executing a second activation function in response to the input value being negative; and providing a value resulted from the execution of the first activation function or the second activation value to a second node of the artificial neural network, wherein the first activation function is a Rectified Linear Unit (ReLU) function, wherein the second activation function is a linear function having a first gradient in a first section of a negative number region and a second gradient in a second section of the negative number region.

### CROSS-REFERENCE TO RELATED APPLICATIONS

This application claims the benefit of priority of Korean Patent Application No. 10-2019-0014432 filed on Feb. 7, 2019, all of which are incorporated by reference in their entirety herein.

### BACKGROUND OF THE INVENTION

### Field of the Invention

The present invention relates to a deep learning algorithm and, more particularly, to a method for executing an activation function for a deep learning algorithm.

### Related Art

Recently, artificial intelligence has been recently drawing attentions in many fields including image recognition. In particular, since overfitting has been solved and hardware has been developed and big data can be achieved, a deep learning algorithm enabled to train itself based on a huge amount of data and find out a pattern is drawing attention and a lot of researches on the deep learning algorithm is ongoing.

Deep learning is a procedure of training an artificial neural network to be optimized, and the artificial neural network is based on the principle of how a neuron in human brain works. When a neuron sends a signal to a next neuron after receiving an input signal and establishing connection, intensity of the signal may become so weak that the signal is not sent to the next neuron or the signal may be sent with strong intensity not as desired. Such intensity is determined as multiplication of a weight of an input value and a sum of deviations of input values pass through an activation function. That is, the activation function has a critical role when it comes to determining strength of connection between neurons. However, researches on the activation function have yet solved many problems, for example, a problem that back propagation learning using a derivative is not possible, Vanishing Gradient problem that accumulated derivate multiplications are converged to 0 and thus learning is not possible, and a problem that backward propagation is not possible in a negative value region. Thus, there is a need of a solution for these problems.

### SUMMARY OF THE INVENTION

One object of the present invention to solve the aforementioned problems is to provide a method for executing an activation function for a deep learning algorithm, the method in which a first activation function is used in a positive value range while a second activation function is used in a negative number region, the second activation function divides one section into multiple sections and includes linear functions having different gradients for the respective sections, and an apparatus for executing the method.

In one general aspect of the present invention to achieve the above object, there is provided a method for executing an activation function for a deep learning algorithm, the method including: determining whether an input value to a first node of an artificial neural network related to the deep learning algorithm is positive or negative; executing a first activation function when the input value is positive, executing a second activation function when the input value is negative; and providing a value resulted from the execution of the first activation function or the second activation value to a second node of the artificial neural network, wherein the first activation function is a Rectified Linear Unit (ReLU) function, wherein the second activation function is a linear function having a first gradient in a first section of a negative number region and a second gradient in a second section of the negative number region, and wherein the first gradient and the second gradient are different.

The second activation function may be based on a sigmoid function.

The first section and the second section of the second activation function may have an equal-length section range.

The first gradient may be determined such that a result value of the second activation function at both ends of the first section have a value related to a result value of scaling a sigmoid function by a predetermined multiple, and the second gradient may be determined such that a result value of the second activation function at both ends of the second section have a value related to a result value of scaling the sigmoid function by a predetermined multiple.

The value related to the result value of scaling the sigmoid function by predetermined multiple may be a value obtained by subtracting a predetermined value from the result value of scaling the sigmoid function by predetermined multiple.

The predetermined multiple for scaling the sigmoid function may have a value of 2, and the predetermined value for the subtraction from the result value of scaling the sigmoid function may have a value of 1.

The second activation function is expressed by a function as below:

$$M ( x ) = \{ \begin{matrix}\frac{{S}^{′} ( {A}_{n} ) - {S}^{′} ( {A}_{n + 1} )}{m} ( x - {A}_{n} ) + {S}^{′} ( {A}_{n} ) & \begin{matrix}\begin{matrix}if {A}_{n} > x > {A}_{n + 1} \\ ( n = 0 , 1 , … , K )\end{matrix} \\ {A}_{0} = 0\end{matrix} \\ & {A}_{i + 1} = {A}_{i} - m \\ & ( i = 0 , 1 , … , K - 1 ) \\ & {A}_{K + 1} = - ∞ \\ - 1 & otherwise\end{matrix} \\ {S}^{′} ( x ) = \frac{2}{1 + {e}^{- x}} - 1$$

where M(x) denotes the second activation function, Aₙ denotes a value of x at an end point of a specific section, n and i denote a section index, m denote a section length, K denote a number of sections having a predetermined length.

A value of m indicating the section length is 2, and a value of K indicating the number of sections is 2.

At least one of m and K may be determined in proportion to a number of nodes of the artificial neural network.

The second activation function may be divided into at least three sections having a predetermined length, and the three divided sections may be executed by linear functions having different gradients.

At least one of the first node and the second node may be a node located at least one of an input layer, a hidden layer, and an output layer of the artificial neural network.

The activation function may be applied to at least one of a Convolution Neural Network (CNN), a Deep Neural Network (DNN), Recurrent Neural Network (RNN), Long Short Term Memory Network (LSTM), and Gated Recurrent Units (GRUs).

In another aspect of the present invention to achieve the above object, there is provided an apparatus for executing a function for deep learning, the apparatus including: a processor configured to determining whether an input value to a first node of an artificial neural network related to the deep learning algorithm is positive or negative, executing a first activation function when the input value is positive, executing a second activation function when the input value is negative, and providing a value resulted from the execution of the first activation function or the second activation value to a second node of the artificial neural network; and a memory configured to store a program related to the first activation function and the second activation function, wherein the first activation function is a Rectified Linear Unit (ReLU) function, wherein the second activation function is a linear function having a first gradient in a first section of a negative number region and a second gradient in a second section of the negative number region, and wherein the first gradient and the second gradient are different.

The second activation function may be based on a sigmoid function.

The first section and the second section of the second activation function may have an equal-length section range.

The first gradient may be determined such that a result value of the second activation function at both ends of the first section have a value related to a result value of scaling a sigmoid function by a predetermined multiple, and the second gradient may be determined such that a result value of the second activation function at both ends of the second section have a value related to a result value of scaling the sigmoid function by a predetermined multiple.

The value related to the result value of scaling the sigmoid function by predetermined multiple may be a value obtained by subtracting a predetermined value from the result value of scaling the sigmoid function by predetermined multiple.

The predetermined multiple for scaling the sigmoid function may have a value of 2, and the predetermined value for the subtraction from the result value of scaling the sigmoid function may have a value of 1.

The second activation function is expressed by a function as below:

$$M ( x ) = \{ \begin{matrix}\frac{{S}^{′} ( {A}_{n} ) - {S}^{′} ( {A}_{n + 1} )}{m} ( x - {A}_{n} ) + {S}^{′} ( {A}_{n} ) & \begin{matrix}\begin{matrix}if {A}_{n} > x > {A}_{n + 1} \\ ( n = 0 , 1 , … , K )\end{matrix} \\ {A}_{0} = 0\end{matrix} \\ & {A}_{i + 1} = {A}_{i} - m \\ & ( i = 0 , 1 , … , K - 1 ) \\ & {A}_{K + 1} = - ∞ \\ - 1 & otherwise\end{matrix} \\ {S}^{′} ( x ) = \frac{2}{1 + {e}^{- x}} - 1$$

where M(x) denotes the second activation function, Aₙ denotes a value of x at an end point of a specific section, n and i denote a section index, m denote a section length, K denote a number of sections having a predetermined length.

### BRIEF DESCRIPTION OF THE DRAWINGS

FIG. 1 is a conceptual diagram showing a configuration of an artificial neural network in which an activation function according to an embodiment of the present invention is executed.

FIG. 2A is a graph showing a step function.

FIG. 2B is a graph showing a sigmoid function.

FIG. 2C is a graph showing a Rectified Linear Unit (ReLU) function.

FIG. 3 is a flowchart schematically showing a method for executing an activation function according to an embodiment of the present invention.

FIG. 4 is a graph of an activation function according to an embodiment of the present invention.

FIG. 5 is a flowchart showing a procedure of generating a second activation function that is executed in a negative number region of an activation function according to an embodiment of the present invention.

FIG. 6 is a block diagram showing an apparatus for executing an activation function according to an embodiment of the present invention.

### DESCRIPTION OF EXEMPLARY EMBODIMENTS

While the invention can be modified in various ways and take on various alternative forms, specific embodiments thereof are shown in the drawings and described in detail below as examples.

However, it should be understood that there is no intent to limit the invention to the particular forms disclosed, but on the contrary, the invention covers all modifications, equivalents, and alternatives falling within the spirit and scope of the present invention.

It will be understood that, although the terms “first,” “second,” etc. may be used herein to describe various elements, these elements should not be limited by these terms. These terms are only used to distinguish one element from another. For example, a first element could be called a second element, and a second element could similarly be called a first element without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements.

The terminology used herein to describe embodiments of the invention is not intended to limit the scope of the invention. The articles “a,” and “an” are singular in that they have a single referent, however, the use of the singular form in the present document should not preclude the presence of more than one referent. In other words, elements of the invention referred to in the singular may number one or more, unless the context clearly indicates otherwise. It will be further understood that the terms “comprise,” “comprising,” “include,” and/or “including,” when used herein, specify the presence of stated features, numbers, steps, operations, elements, components, and/or combinations thereof, but do not preclude the presence or addition of one or more other features, numbers, steps, operations, elements, components, and/or combinations thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, exemplary embodiments of the invention will be described in detail with reference to the accompanying drawings. The same or corresponding elements will be consistently denoted by the same respective reference numerals and described in detail no more than once regardless of drawing symbols.

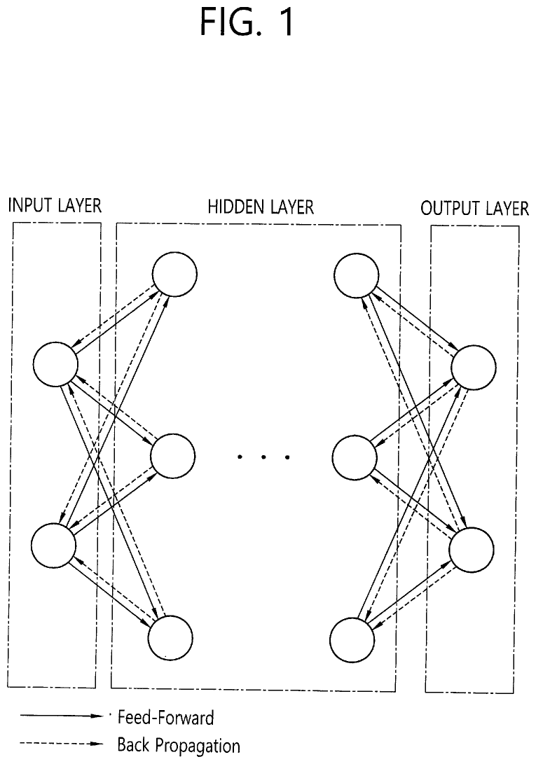

FIG. 1 is a conceptual diagram illustrating an artificial neural network in which an activation function is executed according to an embodiment of the present invention.

Referring to FIG. 1, an artificial neural network in which an activation function is executed according to the present invention includes an input layer, a hidden layer, and an output layer. Basically, the hidden layer may be composed of a numerous number of nodes. The embodiment of FIG. 1 is about an example of a deep neural network which is the typical artificial neural network structure, but aspects of the present invention is not necessarily limited to the example of the deep neural network.

As a method for training a deep neural network, feed-forward marked with a solid line and back propagation marked with a dotted line may be used. In the feed forward, learning is performed in order of the input layer, the hidden layer, and the output layer. A node value of each layer may be a value corresponding to an activation function, the value which is obtained by adding up multiplication of all weights connected to a node value of a previous layer. Then, the activation may be differentiated in order of the output layer, the hidden layer, and the input layer so as to perform backward propagation of an error, thereby optimizing a weight. The activation function is directly involved in the feedforward and backward propagation procedures, thereby greatly influencing learning speed and performance.

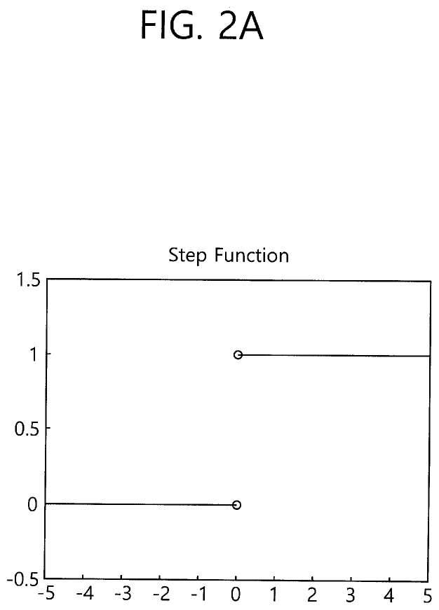

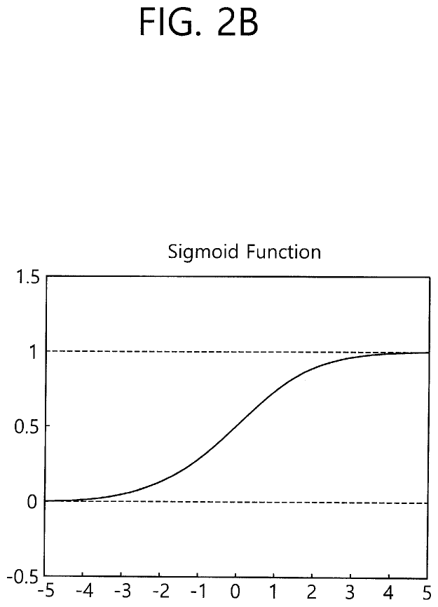

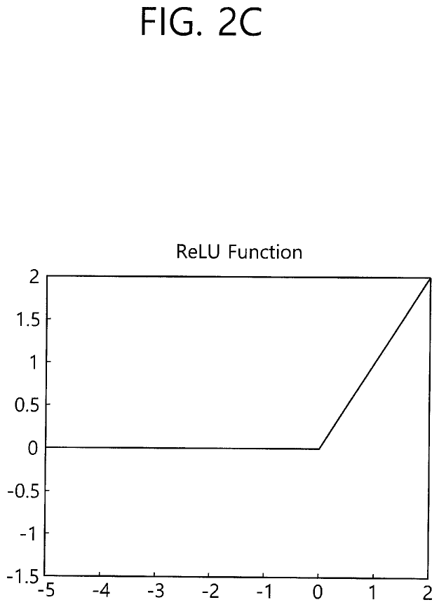

FIG. 2A is a graph showing a step function.

Referring to FIG. 2A, a step function is the basic activation function which is expressed by the following equation.

$$f ( x ) = \{ \begin{matrix}0 , & if x \leq 0 \\ 1 , & if x > 0\end{matrix} \qquad [ Equation 1 ]$$

Activation or inactivation may be expressed by a function which has 1 in response to a positive input value, while having 0 in response to a negative input value. Here, a degree depending on the size of an input value cannot be expressed. In addition, backward learning using a derivative is not possible.

FIG. 2B is a graph showing a sigmoid function.

Referring to FIG. 2B, the sigmoid function is expressed by the following equation.

$$S ( x ) = \frac{1}{1 + {e}^{- x}} \qquad [ Equation 2 ]$$

The sigmoid function is a non-linear function having a value between 0 and 1, and enables backward propagation-type learning using a derivate. An activation function is differentiated in backward propagation-type learning, and the derivate of the sigmoid function is always smaller than 1. Accordingly, a derivate multiple accumulated after passing through too many nodes in the hidden layer of the deep neural network eventually converges into 0, and this may lead to the Vanishing Gradient problem that disenables learning. Thus, this function is not appropriate to use in a deep neural network having a large number of layers.

FIG. 2C is a graph showing the Rectified Linear Unit (ReLU) function.

Referring to FIG. 2C, the ReLU function is expressed by the following equation.

$$f ( x ) = \{ \begin{matrix}x , & if x > 0 \\ 0 , & otherwise\end{matrix} \qquad [ Equation 3 ]$$

The ReLU function is a function that solves the Vanishing Gradient problem of the Sigmoid function shown in FIG. 2B. The derivate of the ReLU function is either 1 or 0, and thus, the ReLU function may solve the Vanishing Gradient problem and the speed of differentiation thereof is 6 times faster compared to the sigmoid function.

However, if most of input values are negative, a derivate of the ReLU function is 0 and it may cause the Dying ReLU problem where backward propagation learning is not possible.

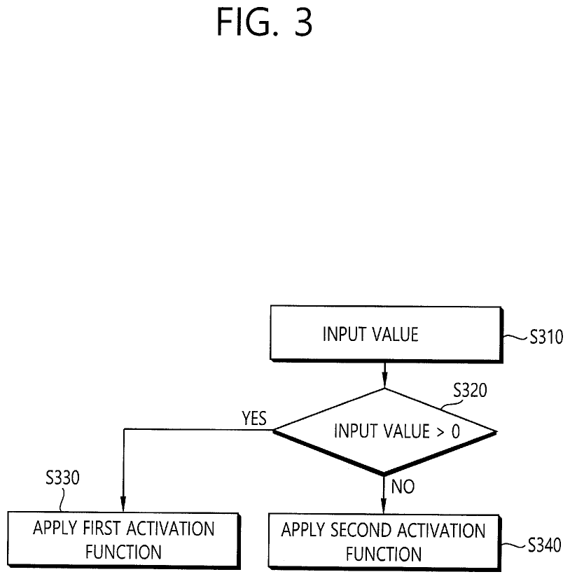

FIG. 3 is a flowchart schematically showing a method for executing an activation function according to an embodiment of the present invention.

In order to solve both the Vanishing Gradient problem and the Dying ReLU problem shown in FIGS. 2A to 2C, an apparatus according to an embodiment of the present invention performs control to apply the ReLU function (the first activation function) function in a positive number region and a function (a second activation function) having a constant gradient in the entire section based on the sigmoid function in a negative number region. According to an embodiment of the present invention, the apparatus is a computing apparatus capable of performing deduction and/or computation and it may include a smart phone, a PC, a tablet PC, a desktop, etc.

Referring to FIG. 3, the apparatus receives an input value from a node of a specific layer (e.g., one of the input layer, the hidden layer, and the output layer) (S310). The apparatus determines if the input value is a positive value or a negative value (S320). If the input value is determined as a positive value, the apparatus applies the ReLU function which is the first activation function (S330). Accordingly, a graph of the first linear function of y=x may be applied. According to an embodiment of the present invention, the first activation function may follow the linear function of y=ax, where “a” can have a value of a real number.

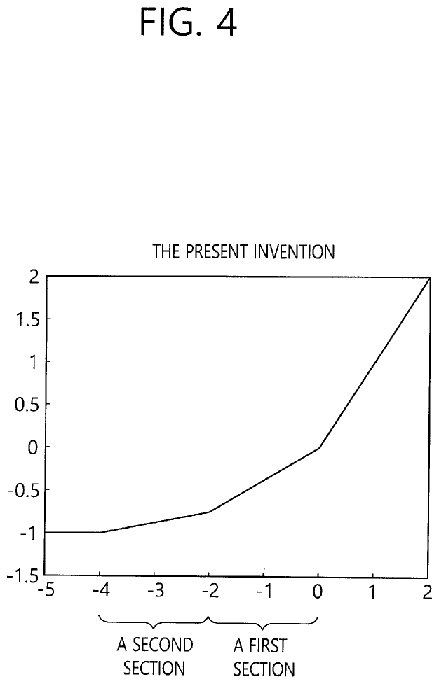

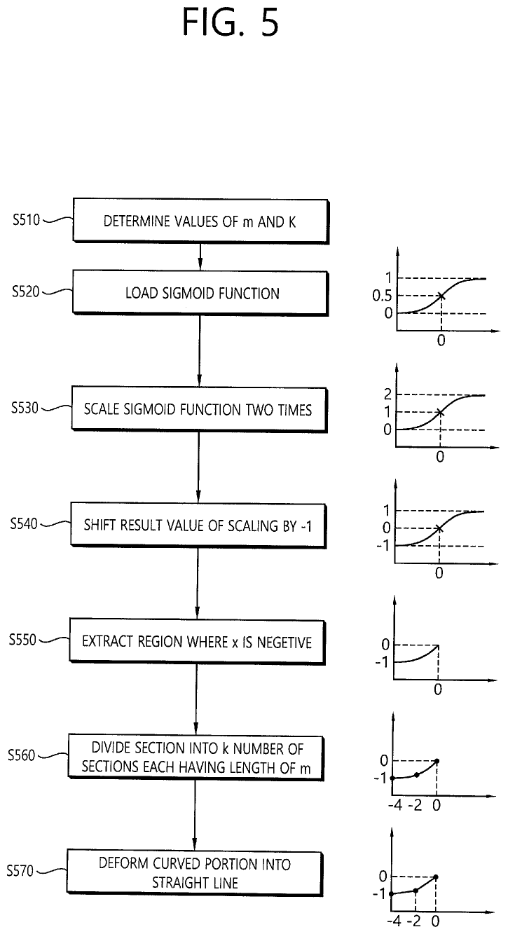

If the input value is a negative value, the second activation function is applied (S340). As described above, the second activation function is a function to be applied only in response to a negative input value, it is a linear function having different gradients for respective sections. This will be described in more detail with reference to FIGS. 4 and 5.

FIG. 4 is a graph showing an activation function according to an embodiment of the present invention.

Referring to FIG. 4, an activation function according to an embodiment of the present invention follows the ReLU function in response to a positive input value, and a second activation function having different gradients based on the sigmoid function in response to a negative input value.

In the embodiment of FIG. 4, the second activation function is set to have a first section and a second section where a gradient in the first section is about 0.4 and a gradient in the second section is about 0.1. The second activation function may be expressed by the following equation.

$$\begin{matrix}M ( x ) = \{ \begin{matrix}\frac{{S}^{′} ( {A}_{n} ) - {S}^{′} ( {A}_{n + 1} )}{m} ( x - {A}_{n} ) + {S}^{′} ( {A}_{n} ) & \begin{matrix}\begin{matrix}if {A}_{n} > x > {A}_{n + 1} \\ ( n = 0 , 1 , … , K )\end{matrix} \\ {A}_{0} = 0\end{matrix} \\ & {A}_{i + 1} = {A}_{i} - m \\ & ( i = 0 , 1 , … , K - 1 ) \\ & {A}_{K + 1} = - ∞ \\ - 1 & otherwise\end{matrix} & [ Equation 4 ] \\ {S}^{′} ( x ) = \frac{2}{1 + {e}^{- x}} - 1 & \end{matrix}$$

Here, M(x) denotes the second activation function, Aₙ denotes an x value of an end point of a specific section, n and i denote section indexes, m denotes a length of a section, and K denotes the number of sections having a predetermined length.

That is, the activation function according to an embodiment of the present invention may vary in different forms depending on values of m and K, and the values may be adjusted according to a learning method in use. The values of m and K may be preset by a user as default values and may be changed arbitrarily by the user. However, if the value of m is too small, the activation function according to an embodiment of the present invention may become identical to the sigmoid function. If the value of K is too great, the Vanishing Gradient problem may happen. Therefore, various methods for setting those values may be considered as below.

According to an embodiment of the present invention, threshold values for m and K may be preset, so that the section may not divided by a length equal to or smaller than a threshold value into the number equal to or smaller than a threshold value.

In particular, at least one value of m and K may be set to have a corresponding value proportional to the number of nodes in the input layer, the hidden layer, and the output layer. That is, in the case where there are too many nodes, when a section divided by setting m to a small value and K to a large value, there may be a problem that backward propagation learning causes convergence into 0. In this case, it is preferable to set m to a relatively large value and K to a relatively small value. On the other hand, if there are few nodes, it is advantageous for learning to divide a section by setting m to a small value and/or setting k to a large value.

According to another embodiment of the present invention, a constant value of m is applied to all section and all the sections have the same length, but this is not necessary all the time. Sections may be set to have different lengths by setting a first section to have a length of 1 and setting a second section to have a length of 2. In this case, when it is assumed that an earlier section index comes in a negative number region closes to 0, it is preferable that a length of a section having an earlier index is longer than a length of a section having a subsequent index. Alternatively, the apparatus may consider the opposite case.

In the embodiment of FIG. 4, the apparatus sets such that a Y-axis value of the second activation function, that is, a result value, varies between 0 and −1, but aspects of the present invention are not necessarily limited thereto. According to another embodiment of the present invention, the result value may vary in a wide range, such as a range from 0 to −2 or a range from 0 to −3. That is, the apparatus may not necessarily operate only in a range of the scale two times the scale of the sigmoid function, and may operate in a range of the scale three, four, five, or more times the scale of the sigmoid function.

FIG. 5 is a flowchart showing a procedure of generating a second activation function that is executed in a negative number region of an activation function according to an embodiment of the present invention.

Referring to FIG. 5, the apparatus may generate a second activation function to be applied in a negative number region, by inferring the second activation function from the sigmoid function. First, the apparatus determines values for m and K (S510). The values for m and K may be preset or may be determined in correspondence with the type of an artificial neural network to be trained and/or the number of nodes in the artificial neural network.

The apparatus loads the sigmoid function (S520). Then, the apparatus scales two times the sigmoid function (S530). At this point, the scaling coefficient is not necessarily 2. The scaling coefficient may be varied by a user's selection, a type of an artificial neural network, and/or the number of nodes.

After scaling the sigmoid function, the apparatus may shift a result value (a Y-axis value) by −1 so that a region of a result value corresponding to a value of x (Y-axis value) in a negative number region operates in a region from 0 to −1 (S540). Then, only a region where the value of x is negative is extracted (S550). This is because a positive number region operates as the first activation function (ReLU function), not the second activation function).

Then, based on m and K in the extracted varied sigmoid function, a section is divided into K number of sections having a length of m (S560). Then, an end value of each section has a result value of the varied sigmoid function.

Then, a curved portion in each section is deformed to a straight line to induce the second activation (S270). Since an end value of each section has a result value of a varied sigmoid function, the apparatus deforms a curved portion to a straight line by connecting end values a straight line. Then, the portion deformed to the straight line is set to have a predetermined gradient, so that a linear value having a different gradient in each section is provided.

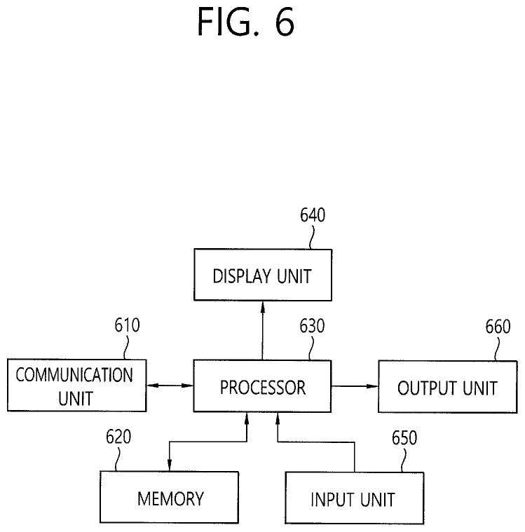

FIG. 6 is a block diagram showing an apparatus that executes an activation function according to an embodiment of the present invention. As shown in FIG. 6, the apparatus according to an embodiment of the present invention includes a communication unit 610, a memory 620, a processor 630, a display unit 640, an input unit 650, and an output unit 660.

Referring to FIG. 6, the memory 620 is connected to the processor 630 via a signal line. The memory 620 may store a formula for an activation function according to an embodiment of the present invention, the function which is executed on a mobile problem, and may store a program related to computation of the processor 630 and a mobile program of a mobile device.

The input unit 650 is connected to the processor 630 via a different signal line, and receives a variable (e.g., m or K) related to the activation function. Alternatively, the input unit 650 may receive a value of choice as to whether to use a default value of m or K or whether to use a value of m or K which varies depending on a type of an artificial neural network and/or the number of nodes in the artificial neural network. The input unit 650 may be implemented as a keyboard, a mouse, a touch pad, etc.

The processor 630 is connected to the communication unit 610, the display unit 640, and the output unit 660. The processor 630 may be implemented as a microprocessor or a Central Processing Unit (CPU). The processor 630 obtains the activation function by applying an input value to the formula for the activation function. Then, the processor 630 calculates an output value corresponding to the input value based on the generated activation function. The processor 630 provides the calculated value to a next node. The processor 630 performs this calculation at each node out of a plurality of nodes so that artificial intelligence learning may be performed smoothly.

In addition, the processor 630 controls fundamental operations for communication and multimedia operation of a portable communication device, such as a smart phone, according to a preset program.

A result of computation related to learning by the processor 630 using an artificial intelligence model may be displayed on the display unit 640 or may be output through the output unit 660.

As such, by reducing complexity of the design of an activation function which guarantees stability or complexity of computation of a method for executing the activation function, an embodiment of the present invention may be implemented as a mobile program.

The apparatus according to an embodiment of the present invention simplifies complex computation so that artificial intelligence learning is enabled even in a mobile program and therefore a variety of artificial intelligence technologies can be implemented by a user anytime and anywhere without constraints.

The above-described system or apparatus may be implemented using hardware components, software components, and/or a combination thereof. For example, the above-described system, apparatus, and components may be implemented using a processing device, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. In addition, the processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable recording mediums.

The method according to embodiments may be implemented as program instructions that can be executed using various computer means and recorded in computer-readable media. The computer-readable media may also include, alone or in combination with the program instructions, data files, data structures, and the like. The program instructions recorded on the media may be those specially designed and constructed for the purposes of example embodiments or may be well-known and available for an ordinary person in computer software industries. Examples of the computer-readable media include magnetic media such as hard disks, floppy disks, and magnetic tapes; optical media such as CD-ROM discs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The above-described hardware devices may be configured to act as one or more software modules in order to perform the operations of the above-described example embodiments, or vice versa.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

The method for executing an activation function for a deep learning algorithm and an apparatus for executing the method according to the present invention have the effect of solving a problem of a conventional activation function, thereby improving learning speed sufficiently.

What is claimed is:

1. A method for executing an activation function for a deep learning algorithm, the method comprising:
determining whether an input value to a first node of an artificial neural network related to the deep learning algorithm is positive or negative;
executing a first activation function in response to the input value being positive, or executing a second activation function in response to the input value being negative; and
providing a value resulted from the execution of the first activation function or the second activation value to a second node of the artificial neural network,
wherein the first activation function is a Rectified Linear Unit (ReLU) function,
wherein the second activation function is a linear function having a first gradient in a first section of a negative number region and a second gradient in a second section of the negative number region, and
wherein the first gradient and the second gradient are different.

2. The method of claim 1, wherein the second activation function is based on a sigmoid function.

3. The method of claim 2, wherein the first section and the second section of the second activation function have an equal-length section range.

4. The method of claim 3,
wherein the first gradient is determined such that a result value of the second activation function at both ends of the first section have a value related to a result value of scaling a sigmoid function by a predetermined multiple, and
wherein the second gradient is determined such that a result value of the second activation function at both ends of the second section have a value related to a result value of scaling the sigmoid function by a predetermined multiple.

5. The method of claim 4, wherein the value related to the result value of scaling the sigmoid function by the predetermined multiple is a value obtained by subtracting a predetermined value from the result value of scaling the sigmoid function by predetermined multiple.

6. The method of claim 5,
wherein the predetermined multiple for scaling the sigmoid function has a value of 2, and
wherein the predetermined value for the subtraction from the result value of scaling the sigmoid function has a value of 1.

7. The method of claim 6, wherein the second activation function is expressed by a function as below:
$$M ( x ) = \{ \begin{matrix}\frac{{S}^{′} ( {A}_{n} ) - {S}^{′} ( {A}_{n + 1} )}{m} ( x - {A}_{n} ) + {S}^{′} ( {A}_{n} ) & \begin{matrix}\begin{matrix}if {A}_{n} > x > {A}_{n + 1} \\ ( n = 0 , 1 , … , K )\end{matrix} \\ {A}_{0} = 0\end{matrix} \\ & {A}_{i + 1} = {A}_{i} - m \\ & ( i = 0 , 1 , … , K - 1 ) \\ & {A}_{K + 1} = - ∞ \\ - 1 & otherwise\end{matrix} \\ {S}^{′} ( x ) = \frac{2}{1 + {e}^{- x}} - 1$$
where M(x) denotes the second activation function, Aₙ denotes a value of x at an end point of a specific section, n and i denote a section index, m denotes a section length, K denotes a number of sections having a predetermined length.

8. The method of claim 7,
wherein a value of m indicating the section length is 2, and a value of K indicating the number of sections is 2.

9. The method of claim 7, wherein at least one of m and K are determined in proportion to a number of nodes of the artificial neural network.

10. The method of claim 1,
wherein the second activation function is divided into at least three sections having a predetermined length, and
wherein the three divided sections are executed by linear functions having different gradients.

11. The method of claim 1, wherein at least one of the first node and the second node is a node located at least one of an input layer, a hidden layer, and an output layer of the artificial neural network.

12. The method of claim 1, wherein the activation function is applied to at least one of a Convolution Neural Network (CNN), a Deep Neural Network (DNN), Recurrent Neural Network (RNN), Long Short Term Memory Network (LSTM), and Gated Recurrent Units (GRUs).

13. An apparatus for executing a function for deep learning, the apparatus comprising:
a processor configured to determining whether an input value to a first node of an artificial neural network related to the deep learning algorithm is positive or negative, executing a first activation function in response to the input value being positive, or executing a second activation function in response to the input value being negative, and providing a value resulted from the execution of the first activation function or the second activation value to a second node of the artificial neural network; and
a memory configured to store a program related to the first activation function and the second activation function,
wherein the first activation function is a Rectified Linear Unit (ReLU) function,
wherein the second activation function is a linear function having a first gradient in a first section of a negative number region and a second gradient in a second section of the negative number region, and
wherein the first gradient and the second gradient are different.

14. The apparatus of claim 13, wherein the second activation function is based on a sigmoid function.

15. The apparatus of claim 14, wherein the first section and the second section have an equal-length section range.

16. The apparatus of claim 15, wherein the first gradient is determined such that a result value of the second activation function at both ends of the first section have a value related to a result value of scaling a sigmoid function by a predetermined multiple, and
wherein the second gradient is determined such that a result value of the second activation function at both ends of the second section have a value related to a result value of scaling the sigmoid function by a predetermined multiple.

17. The method of claim 16, wherein the value related to the result value of scaling the sigmoid function by the predetermined multiple is a value obtained by subtracting a predetermined value from the result value of scaling the sigmoid function by predetermined multiple.

18. The method of claim 17,
wherein the predetermined multiple for scaling the sigmoid function has a value of 2,
wherein the predetermined value for the subtraction from the result value of scaling the sigmoid function has a value of 1.

19. The method of claim 18, wherein the second activation function is expressed by a function as below:
$$M ( x ) = \{ \begin{matrix}\frac{{S}^{′} ( {A}_{n} ) - {S}^{′} ( {A}_{n + 1} )}{m} ( x - {A}_{n} ) + {S}^{′} ( {A}_{n} ) & \begin{matrix}\begin{matrix}if {A}_{n} > x > {A}_{n + 1} \\ ( n = 0 , 1 , … , K )\end{matrix} \\ {A}_{0} = 0\end{matrix} \\ & {A}_{i + 1} = {A}_{i} - m \\ & ( i = 0 , 1 , … , K - 1 ) \\ & {A}_{K + 1} = - ∞ \\ - 1 & otherwise\end{matrix} \\ {S}^{′} ( x ) = \frac{2}{1 + {e}^{- x}} - 1$$
where M(x) denotes the second activation function, Aₙ denotes a value of x at an end point of a specific section, n and i demote a section index, m denotes a section length, K denotes a number of sections having a predetermined length.
